(19) United States
(12) Patent Application Publication
(10) Pub. No.: US 2013/0179556 A1
(43) Pub. Date: Jul. 11, 2013

(54) INFORMATION PROCESSING DEVICE, APPARATUS MANAGEMENT SYSTEM, AND COMPUTER PROGRAM PRODUCT

(71) Applicants: Kaname KUROKAWA, Chiba (JP); Kana Takami, Kanagawa (JP)

(72) Inventors: Kaname KUROKAWA, Chiba (JP); Kana Takami, Kanagawa (JP)

(21) Appl. No.: 13/738,241

(22) Filed: Jan. 10, 2013

(30) Foreign Application Priority Data
Jan. 11, 2012 (JP) 2012-003350

(51) Int. Cl. H04L 12/24

(52) U.S. Cl. CPC H04L 41/24
USPC 709/223

(57) ABSTRACT

According to an embodiment, provided is an information processing device that is capable of communicating with an apparatus through a first communication path and is capable of communicating with an apparatus management device for managing the apparatus through a second communication path. The information processing device includes: a searching unit that searches apparatuses capable of communicating with the information processing device; a registration requesting unit that requests the apparatus capable of communicating with the information processing device through the first communication path among the searched apparatuses to register thereto management information for the apparatus; and a notifying unit that notifies the apparatus management device of the management information based on notification indicating a fact that the management information has been registered from the apparatus.

### CROSS-REFERENCE TO RELATED APPLICATIONS

The present application claims priority to and incorporates by reference the entire contents of Japanese Patent Application No. 2012-003350 filed in Japan on Jan. 11, 2012.

### BACKGROUND OF THE INVENTION

1. Field of the Invention

The present invention relates to an information processing device, an apparatus management system, and a computer program product.

2. Description of the Related Art

Conventionally known are apparatus management devices that manage an apparatus connected through network. Among the apparatus management devices, there are devices that manage apparatuses, the apparatuses being connected to an information processing device such as a personal computer (PC) through communication interfaces including USB (Universal Serial Bus) cable and the like (for example, see Japanese Patent Application Laid-open No. 2009-238203 and Japanese Patent Application Laid-open No. 2010-108357).

However, with the above-mentioned conventional techniques, manual registration has been required for a user in order to set the apparatuses connected to the information processing device as targets to be managed by the apparatus management device.

There is a need to provide an information processing device, an apparatus management system, and a computer program product that can set an apparatus connected to the information processing device as a target to be managed by an apparatus management device.

### SUMMARY OF THE INVENTION

It is an object of the present invention to at least partially solve the problems in the conventional technology.

According to an embodiment, provided is an information processing device that is capable of communicating with an apparatus through a first communication path and is capable of communicating with an apparatus management device for managing the apparatus through a second communication path. The information processing device includes: a searching unit that searches apparatuses capable of communicating with the information processing device; a registration requesting unit that requests the apparatus capable of communicating with the information processing device through the first communication path among the searched apparatuses to register thereto management information for the apparatus; and a notifying unit that notifies the apparatus management device of the management information based on notification indicating a fact that the management information has been registered from the apparatus.

According to another embodiment, provided is an apparatus management system that includes: an information processing device that is capable of communicating with an apparatus through a first communication path and is capable of communicating with an apparatus management device for managing the apparatus through a second communication path, and the apparatus management. The information processing device includes: a searching unit that searches apparatuses capable of communicating with the information processing device; a registration requesting unit that requests the apparatus capable of communicating with the information processing device through the first communication path among the searched apparatuses to register thereto management information for the apparatus; and a notifying unit that notifies the apparatus management device of the management information based on notification indicating a fact that the management information has been registered from the apparatus. The apparatus management device includes a management unit that manages the apparatus based on the management information notified from the information processing device.

According to still another embodiment, provided is a computer program product that includes a non-transitory computer usable medium having computer readable program codes embodied in the medium that when executed causes a computer that is capable of communicating with an apparatus through a first communication path and is capable of communicating with an apparatus management device for managing the apparatus through a second communication path to execute a method for the computer to process information. The method includes: searching apparatuses capable of communicating with the information processing device; transmitting a registration request of management information to the apparatus capable of communicating with the information processing device through the first communication path among the searched apparatuses; and notifying the apparatus management device of the management information based on notification indicating a fact that the management information has been registered from the apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of an apparatus management system according to a first embodiment;

FIG. 2 is a block diagram illustrating an example of a configuration of a PC according to the first embodiment;

FIG. 3 is a block diagram illustrating an example of a configuration of an apparatus according to the first embodiment;

FIG. 4 is a block diagram illustrating an example of a configuration of an apparatus management device according to the first embodiment;

FIG. 5 is a view illustrating an example of a confirmation screen according to the first embodiment;

FIG. 6 is a sequence diagram illustrating an example of processing that is executed on the apparatus management system according to the first embodiment;

FIG. 7 is a block diagram illustrating an example of a PC of an apparatus management system according to a second embodiment;

FIG. 8 is a block diagram illustrating an example of a configuration of an apparatus management device of the apparatus management system according to the second embodiment;

FIG. 9 is a view illustrating an example of a confirmation screen according to the second embodiment;

FIG. 10 is a sequence diagram illustrating an example of processing that is executed on the apparatus management system according to the second embodiment;

FIG. 11 is a flowchart illustrating an example of operation state analysis processing that is executed by an analyzing unit of a local apparatus management application according to the second embodiment;

FIG. 12 is a block diagram illustrating an example of a hardware configuration of the PC and the apparatus management device according to the first and the second embodiments; and

FIG. 13 is a block diagram illustrating an example of a hardware configuration of the apparatus according to the first and the second embodiments.

### DETAILED DESCRIPTION OF THE PREFERRED EMBODIMENTS

Hereinafter, embodiments of an information processing device, an apparatus management system, and a computer program product are described in detail with reference to the accompanying drawings.

### First Embodiment

First, a configuration of an apparatus management system including an information processing device according to a first embodiment is described.

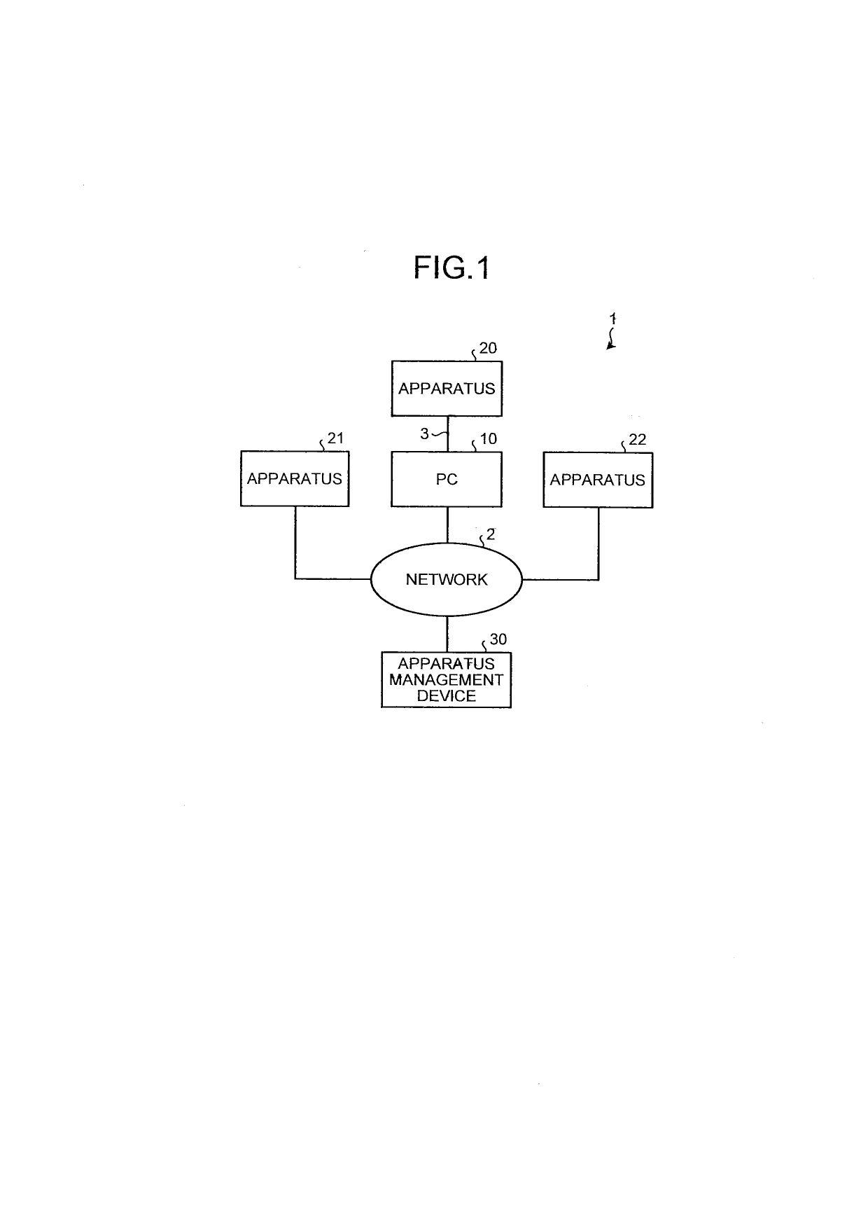

FIG. 1 is a block diagram illustrating an example of a configuration of an apparatus management system 1 according to the first embodiment. As illustrated in FIG. 1, the apparatus management system 1 includes a personal computer (PC) 10 (an example of the information processing device), apparatuses 20 to 22, and an apparatus management device 30.

The PC 10, the apparatuses 21 and 22, and the apparatus management device 30 are connected to one another through a network 2 (an example of a second communication path). The PC 10 and the apparatus 20 are connected to each other through a communication interface 3 (an example of a first communication path). The network 2 can be realized by the Internet, a local area network (LAN), or the like, for example. The communication interface 3 can be realized by a universal serial bus (USB) cable or the like, for example.

The apparatus management device 30 is provided on a service center of a service provision company that provides an apparatus management service and manages the PC 10 and the apparatuses 20 to 22 that are provided on service bases. However, an installation place of the apparatus management device 30 is not limited to the service center and may be the service base or the like. The service base is an area on which an apparatus as a management target is installed and corresponds to a business place of a company that receives the apparatus management service, for example.

A local apparatus management program, which will be described later, is installed on the PC 10 and the PC 10 manages the apparatus 20 connected to the PC 10 through the communication interface 3.

It is sufficient that the apparatus 20 is an apparatus that can be connected to the communication interface 3. It is sufficient that the apparatuses 21 and 22 are apparatuses that can be connected to the network 2. The apparatuses 20 to 22 correspond to image forming devices such as a printing device, a copying machine, a multifunction peripheral (MFP), a scanner device and a facsimile device, electronic apparatuses of various types such as a projector, a camera, an air conditioner, a refrigerator, a fluorescent lamp, a vending machine and a hand held-type terminal, and the like. The MFP has at least two functions out of a copying function, a printing function, a scanner function, and a facsimile function. It is to be noted that in the first embodiment, description is made using a case in which the apparatuses 20 and 21 are printing devices and the apparatus 22 is the MFP as an example.

The apparatus management device 30 manages the PC 10 and the apparatuses 20 to 22 and can be realized by, for example, a PC on which an apparatus management program, which will be described later, has been installed. In FIG. 1, the PC 10 and the apparatuses 20 to 22 are illustrated but the apparatuses as targets to be managed by the apparatus management device 30 are not limited thereto.

Hereinafter, an example in which the apparatuses 21 and 22 have been already set as the targets to be managed by the apparatus management device 30 and the PC 10 and the apparatus 20 are set to be apparatuses as targets to be managed by the apparatus management device 30 newly is described.

In the following description, an apparatus connected to the network 2 is referred to as a network apparatus and an apparatus connected to the communication interface 3 is referred to as a local apparatus in some cases.

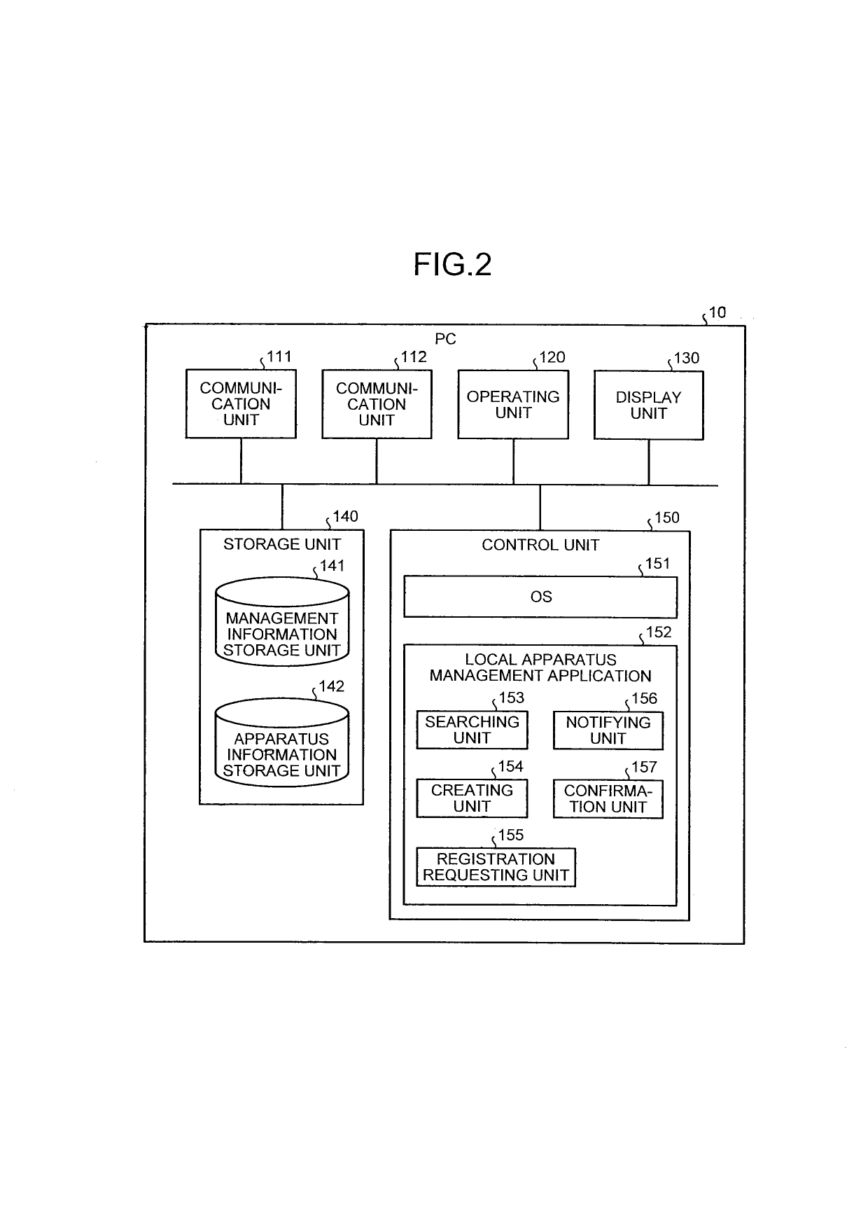

FIG. 2 is a block diagram illustrating an example of a configuration of the PC 10 according to the first embodiment. As illustrated in FIG. 2, the PC 10 includes a communication unit 111, a communication unit 112, an operating unit 120, a display unit 130, a storage unit 140, and a control unit 150.

The communication unit 111 communicates with an external device such as the apparatus management device 30 through the network 2 and can be realized by a network interface card (NIC).

The communication unit 112 communicates with a local apparatus such as the apparatus 20 through the communication interface 3 and can be realized by a USB or the like.

The operating unit 120 performs input of various types of operations and can be realized by an input device such as a keyboard, a mouse, a touch pad, and a touch panel.

The display unit 130 displays various types of screens and can be realized by a display device such as a liquid crystal display and a touch panel-type display.

The storage unit 140 stores therein various types of computer programs including an operating system (OS) program and an apparatus management program to be executed by the PC 10, data to be used for various types of processing to be performed by the PC 10, such as the apparatus name, the model number, and the manager information of the PC 10, and the like. The storage unit 140 can be realized by at least any one of storage devices that can store them magnetically, optically and electrically, such as a hard disk drive (HDD), a solid state drive (SSD), a memory card, an optical disk, a read only memory (ROM), and a random access memory (RAM), for example.

The storage unit 140 includes a management information storage unit 141 and an apparatus information storage unit 142. The management information storage unit 141 stores therein management information of the PC 10. The management information of the PC 10 is information to be used for apparatus management by the apparatus management device 30 and is set by the apparatus management device 30 previously. To be more specific, the local apparatus management program is distributed (downloaded) to the PC 10 from the apparatus management device 30 and is installed on the storage unit 140, so that the management information of the PC 10 is stored in the management information storage unit 141. The apparatus information storage unit 142 will be described later.

The control unit 150 controls each part of the PC 10 and can be realized by a control device such as a central processing unit (CPU). The control unit 150 includes an OS 151 and a local apparatus management application 152. The control unit 150 activates (executes) the OS program and the local apparatus management program stored in the storage unit 140 so as to realize the OS 151 and the local apparatus management application 152 as software.

The OS 151 controls each part (to be more specific, hardware and software of the PC 10) of the PC 10 and can be realized by basic software such as Windows (registered trademark) and UNIX (registered trademark).

The local apparatus management application 152 manages the apparatus 20 through the communication interface 3 and includes a searching unit 153, a creating unit 154, a registration requesting unit 155, a notifying unit 156, and a confirmation unit 157.

The searching unit 153 searches apparatuses that can communicate with the PC 10. The searching unit 153 performs communication through the communication interface 3 with a printer job language (PJL) or the like, and communication through the network 2 with a predetermined communication protocol such as a simple network management protocol (SNMP) so as to search a new apparatus (that has not been set as a management target), for example. With this, the apparatus 20 is searched.

The creating unit 154 creates management information for the apparatus 20 searched by the searching unit 153. The creating unit 154 creates the management information for the apparatus 20 searched by the searching unit 153 using management information of the PC 10 that has been set by the apparatus management device 30 previously, that is, the management information of the PC 10 that is stored in the management information storage unit 141, for example. The creating unit 154 creates (unique) management information different from management information that has been already used for apparatus management by the apparatus management device 30 using the management information of the PC 10 that is stored in the management information storage unit 141. The creation method thereof is not limited as long as the creating unit 154 can create management information different from the information that has been already used for the apparatus management by the apparatus management device 30. For example, the creating unit 154 increments the management information of the PC 10 so as to create the management information of the apparatus 20, or the creating unit 154 generates a random number from the management information of the PC 10 so as to set it as the management information of the apparatus 20.

The registration requesting unit 155 requests registration of the management information for the apparatus 20 with which the PC 10 can communicate through the communication interface 3 among the apparatuses searched by the searching unit 153. To be more specific, the registration requesting unit 155 requests the apparatus 20 to register the management information for the apparatus 20 that has been created by the creating unit 154.

The registration requesting unit 155 transmits a PJL command for requesting the apparatus 20 to register the management information for the apparatus 20 that has been created by the creating unit 154 to the apparatus 20, for example. If the apparatus 20 has registered the management information, the registration requesting unit 155 receives a response command including the management information, the apparatus name and the model number of the apparatus 20, and the registration date of the management information from the apparatus 20. Then, the registration requesting unit 155 registers (stores) the management information, the apparatus name, the model number, and the registration date of the apparatus 20 that have been received in the apparatus information storage unit 142 in a correspondence manner.

It is to be noted that the registration requesting unit 155 also registers (stores) management information, the apparatus name, the model number, and the registration date of the PC 10 into the apparatus information storage unit 142 in a correspondence manner. If the local apparatus management program has been installed on the PC 10, the registration requesting unit 155 performs the processing, for example.

The notifying unit 156 notifies the apparatus management device 30 of the management information based on a notification indicating a fact that the management information has been registered from the apparatus 20. The notifying unit 156 notifies the apparatus management device 30 of the management information, the apparatus name, the model number, and the registration date of the apparatus 20 that have been responded from the apparatus 20 and manager information of the apparatus 20 through the OS 151, for example. In this case, the notifying unit 156 notifies the apparatus management device 30 of the manager information of the PC 10 as the manager information of the apparatus 20. It is to be noted that the notifying unit 156 also notifies the apparatus management device 30 of the management information, the apparatus name, the model number, the registration date, and the manager information of the PC 10 through the OS 151.

The confirmation unit 157 confirms a state of the apparatus 20 of which management information has been registered.

For example, if a state confirmation of the apparatus is requested by the apparatus management device 30 through the OS 151, the confirmation unit 157 confirms a state of the PC 10 and stores a confirmation date in the apparatus information storage unit 142 so as to correspond to the management information of the PC 10. Note that the state confirmation includes confirmation of presence/absence of an operation, for example.

Furthermore, if the state confirmation of the apparatus is requested by the apparatus management device 30, the confirmation unit 157 transmits a PJL command for requesting confirmation of the state of the apparatus 20 to the apparatus 20 and receives a response command including the management information, the apparatus name, the model number, and a confirmation date from the apparatus 20. Then, the confirmation unit 157 stores the confirmation date included in the received response command in the apparatus information storage unit 142 so as to correspond to the management information of the apparatus 20.

When the state confirmation is to confirm presence/absence of an operation, the confirmation unit 157 transmits the PJL command for requesting confirmation of presence/absence of the operation of the apparatus 20 to the apparatus 20. If the apparatus 20 is operated, the confirmation unit 157 receives the response command including the management information, the apparatus name, the model number, and the confirmation date from the apparatus 20. On the other hand, if the apparatus 20 is not operated, the confirmation unit 157 does not receive the response command from the apparatus 20. If the confirmation unit 157 has received the response command, the confirmation unit 157 stores the confirmation date included in the received response command in the apparatus information storage unit 142 so as to correspond to the management information of the apparatus 20.

In addition, the notifying unit 156 notifies the apparatus management device 30 of the confirmation result by the confirmation unit 157. The notifying unit 156 notifies the apparatus management device 30 of the management information, the apparatus name, the model number, and the confirmation date of the PC 10 through the OS 151, for example. It is to be noted that the notifying unit 156 also notifies the apparatus management device 30 of the management information, the apparatus name, the model number, and the confirmation date of the apparatus 20 that have been responded from the apparatus 20 through the OS 151.

It is to be noted that all of the above-described parts of the PC 10 are not required to be configured essentially; and a part of them may be omitted.

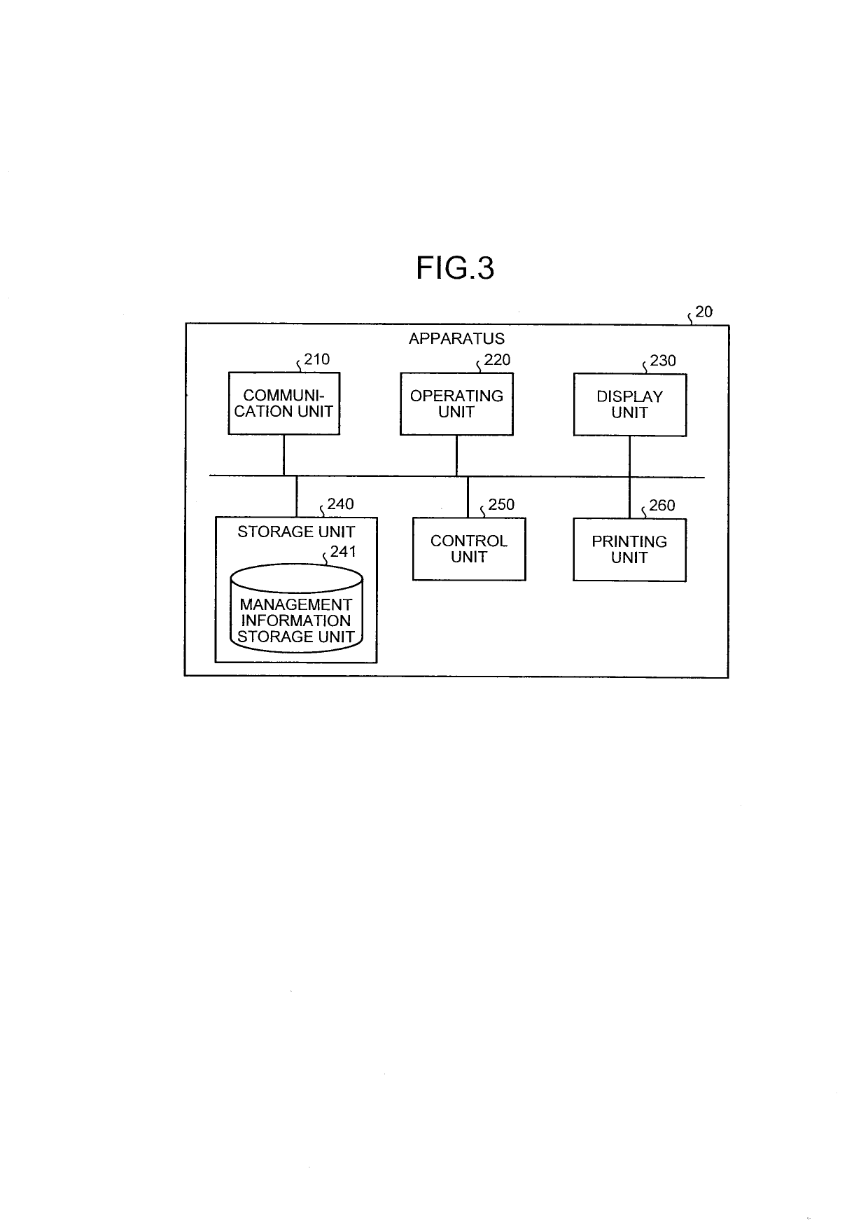

FIG. 3 is a block diagram illustrating an example of a configuration of the apparatus 20 according to the first embodiment. As illustrated in FIG. 3, the apparatus 20 includes a communication unit 210, an operating unit 220, a display unit 230, a storage unit 240, a control unit 250, and a printing unit 260.

The communication unit 210 communicates with the PC 10 through the communication interface 3 and can be realized by a USB or the like.

The operating unit 220 performs input of various types of operations and can be realized by an input device such as a keyboard, a mouse, a touch pad, and a touch panel.

The display unit 230 displays various types of screens and can be realized by a display device such as a liquid crystal display and a touch panel-type display.

The storage unit 240 stores therein various types of computer programs to be executed by the apparatus 20, data to be used for various types of processing to be performed by the apparatus 20, such as the apparatus name and the model number of the apparatus 20. The storage unit 240 can be realized by at least any one of storage devices that can store them magnetically, optically and electrically, such as an HDD, an SSD, a memory card, an optical disk, a ROM, and a RAM, for example.

The storage unit 240 includes a management information storage unit 241. The management information storage unit 241 stores therein management information of the apparatus 20. The management information of the apparatus 20 is information to be used for apparatus management by the apparatus management device 30 and local apparatus management by the PC 10 and is registered by the PC 10.

The control unit 250 controls each part of the apparatus 20 and can be realized by a control device such as a CPU. If the control unit 250 has received a PJL command for requesting registration of the management information from the PC 10; the control unit 250 registers (stores) the management information in the management information storage unit 241. Then, the control unit 250 transmits a response command including the management information, the apparatus name, the model number, and the registration date to the PC 10. If the control unit 250 has received a PJL command for requesting confirmation of a state from the PC 10, the control unit 250 confirms a state of the apparatus 20 and transmits a response command including the management information, the apparatus name, the model number, and the confirmation date to the PC 10.

If printing is requested by the PC 10, the printing unit 260 executes printing.

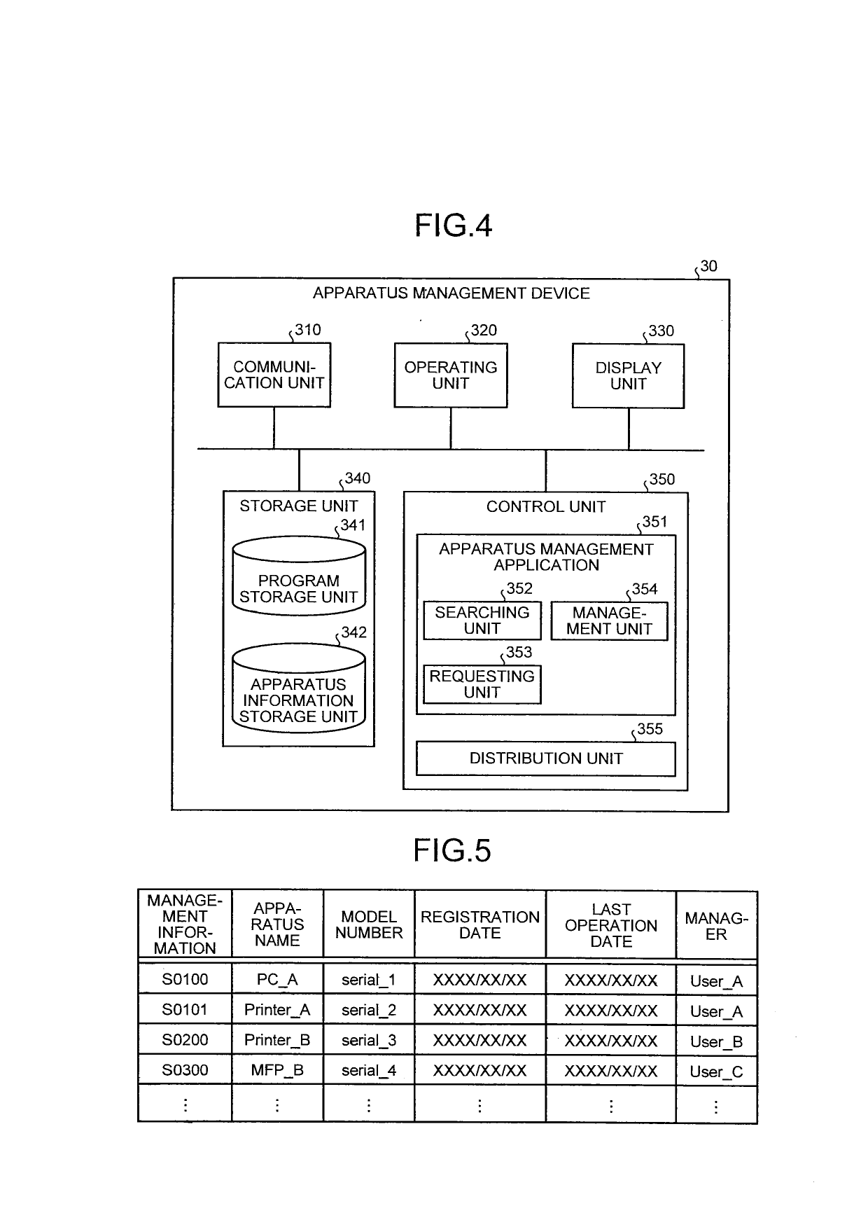

FIG. 4 is a block diagram illustrating an example of a configuration of the apparatus management device 30 according to the first embodiment. As illustrated in FIG. 4, the apparatus management device 30 includes a communication unit 310, an operating unit 320, a display unit 330, a storage unit 340, and a control unit 350.

The communication unit 310 communicates with network apparatuses such as the PC 10 and the apparatuses 21 and 22 through the network 2 and can be realized by an NIC or the like.

The operating unit 320 performs input of various types of operations and can be realized by an input device such as a keyboard, a mouse, a touch pad, and a touch panel.

The display unit 330 displays various types of screens and can be realized by a display device such as a liquid crystal display and a touch panel-type display.

The storage unit 340 stores therein various types of computer programs including an apparatus management program to be executed by the apparatus management device 30, data to be used for various types of processing to be performed by the apparatus management device 30, and the like. The storage unit 340 can be realized by at least any one of storage devices that can store them magnetically, optically and electrically, such as an HDD, an SSD, a memory card, an optical disk, a ROM, and a RAM, for example.

The storage unit 340 includes a program storage unit 341 and an apparatus information storage unit 342. The program storage unit 341 stores therein the local apparatus management program. The apparatus information storage unit 342 will be described later.

The control unit 350 controls each part of the apparatus management device 30 and can be realized by a control device such as a CPU. The control unit 350 includes an apparatus management application 351 and a distribution unit 355. The control unit 350 activates (executes) the apparatus management program stored in the storage unit 340 so as to realize the apparatus management application 351 as software.

The apparatus management application 351 manages apparatuses as management targets and includes a searching unit 352, a requesting unit 353, and a management unit 354.

The searching unit 352 searches network apparatuses. The searching unit 352 transmits a request such as a packet internet grouper (PING) or an SNMP to an IP address of a search destination through the network so as to search a new network apparatus (that has not been set to be a management target), for example. In this case, as described above, the PC 10 is assumed to be an apparatus to be managed by the apparatus management device 30 newly, so that the PC 10 is searched.

If the new network apparatus has been searched by the searching unit 352, the requesting unit 353 requests the distribution unit 355 to distribute the local apparatus management program to the network apparatus and notifies the distribution unit 355 of management information to be set for the network apparatus. It is to be noted that the requesting unit 353 notifies the distribution unit 355 of the management information that is not stored in the apparatus information storage unit 342, which will be described later.

If the distribution unit 355 has been requested to distribute the local apparatus management program from the apparatus management application 351, the distribution unit 355 acquires the local apparatus management program from the program storage unit 341, sets the management information notified from the apparatus management application 351 for the local apparatus management program, and distributes it to the requested network apparatus.

The management unit 354 manages the apparatuses as management targets.

The management unit 354 acquires management information, the apparatus name, the model number, the registration date, and the manager information of the network apparatus from the network apparatus to which the local apparatus management program has been distributed by the distribution unit 355. Then, the management unit 354 stores the management information, the apparatus name, the model number, the registration date, and the manager information that have been acquired in the apparatus information storage unit 342 in a correspondence manner.

When a local apparatus is connected to the network apparatus to which the local apparatus management program has been distributed by the distribution unit 355 through the communication interface 3, the management unit 354 also acquires the management information, the apparatus name, the model number, the registration date, and the manager information of the local apparatus from the network apparatus. Then, the management unit 354 stores the management information, the apparatus name, the model number, the registration date, and the manager information that have been acquired in the apparatus information storage unit 342 in a correspondence manner.

With this, the pieces of management information, the apparatus names, the model numbers, the registration dates, and the pieces of manager information of the PC 10 and the apparatus 20 are stored in the apparatus information storage unit 342 and the PC 10 and the apparatus 20 are set to be (are registered as) apparatuses as targets to be managed by the apparatus management device 30 newly. It is to be noted that pieces of management information, apparatus names, model numbers, registration dates, and pieces of manager information of the apparatuses 21 and 22 have been already stored in the apparatus information storage unit 342, and the apparatuses 21 and 22 have been already set to be (have been registered as) apparatuses as targets to be managed by the apparatus management device 30.

Furthermore, the management unit 354 requests the network apparatuses as the management targets such as the PC 10 and the apparatuses 21 and 22 to confirm states thereof and acquires the pieces of management information, the apparatus names, the model numbers, and the registration dates of the network apparatuses. The management unit 354 requests the network apparatuses to confirm the states thereof once per day, for example. Then, the management unit 354 stores the acquired confirmation dates in the apparatus information storage unit 342 so as to correspond to the pieces of management information of the network apparatuses. In this manner, the management unit 354 manages the network apparatuses as the management targets such as the PC 10 and the apparatuses 21 and 22 through the network 2.

When a local apparatus is connected to the network apparatus to which the state confirmation has been requested through the communication interface 3, the management unit 354 also acquires the management information, the apparatus name, the model number, and the confirmation date of the local apparatus from the network apparatus. Then, the management unit 354 stores the acquired confirmation date in the apparatus information storage unit 342 so as to correspond to the management information of the local apparatus. In this manner, the management unit 354 manages the local apparatus as the management target such as the apparatus 20 that is connected to the PC 10 through the communication interface 3 through the PC 10. That is to say, the management unit 354 manages the local apparatus based on the management information of the local apparatus that has been notified from the PC 10.

Furthermore, the management unit 354 displays a confirmation screen of the pieces of information of the apparatuses as the management targets such as the PC 10 and the apparatuses 20 to 22 on the display unit 330.

FIG. 5 is a view illustrating an example of the confirmation screen according to the first embodiment. In the example as illustrated in FIG. 5, the management unit 354 generates a confirmation screen using the pieces of management information, the apparatus names, the model numbers, the registration dates, latest confirmation dates (corresponding to last operation dates), and the pieces of manager information (corresponding to managers) that are stored in the apparatus information storage unit 342 and displays the generated confirmation screen on the display unit 330. Note that in the example as illustrated in FIG. 5, management information “S0100” indicates the PC 10, management information “S0101” indicates the apparatus 20, management information “S0200” indicates the apparatus 21, and management information “S0300” indicates the apparatus 22.

It is to be noted that all of the above-described parts of the apparatus management device 30 are not required to be configured essentially and a part of them may be omitted.

Next, operations of the apparatus management system including the information processing device according to the first embodiment are described.

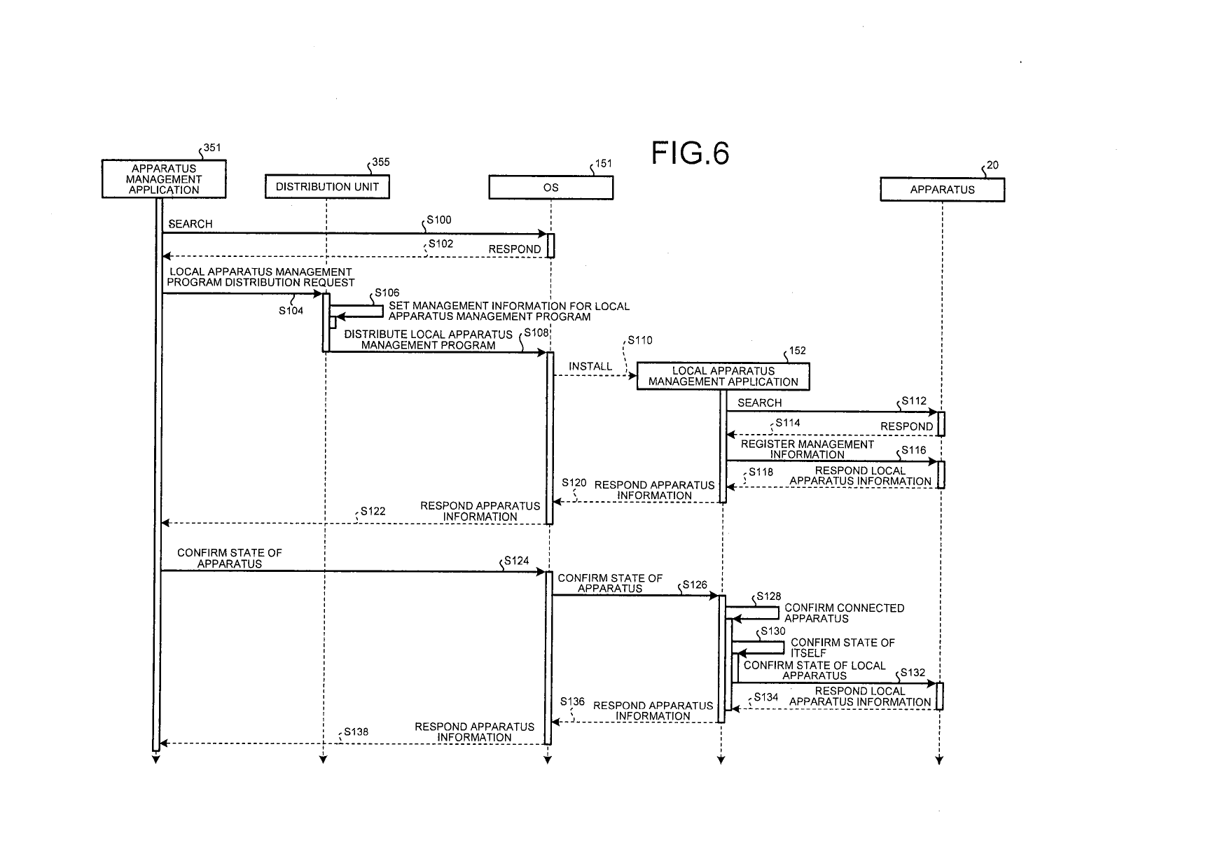

FIG. 6 is a sequence diagram illustrating an example of processing that is executed on the apparatus management system 1 according to the first embodiment.

First, the searching unit 352 of the apparatus management application 351 of the apparatus management device 30 transmits a request to an IP address of a search destination so as to search a new network apparatus (step S100). In this case, the IP address of the search destination is assumed to be an IP address of the PC 10.

Subsequently, the OS 151 of the PC 10 responds to the request to the apparatus management device 30 (step S102).

Then, if the PC 10 has been searched by the searching unit 352, the requesting unit 353 of the apparatus management application 351 requests the distribution unit 355 to distribute a local apparatus management program to the PC 10 and notifies the distribution unit 355 of the management information to be set for the PC 10 (step S104).

Subsequently, if the distribution unit 355 of the apparatus management device 30 has been requested to distribute the local apparatus management program from the apparatus management application 351, the distribution unit 355 acquires the local apparatus management program from the program storage unit 341, sets the management information notified from the apparatus management application 351 for the local apparatus management program (step S106), and distributes it to the PC 10 (step S108).

Thereafter, if the local apparatus management program has been distributed from the apparatus management device 30, the OS 151 of the PC 10 installs the local apparatus management program in the storage unit 140 (step S110). With this, the management information of the PC 10 is stored in the management information storage unit 141. Then, the OS 151 activates (executes) the local apparatus management program stored in the storage unit 140 so as to realize the local apparatus management application 152 as software.

Then, the registration requesting unit 155 of the local apparatus management application 152 of the PC 10 registers the management information, the apparatus name, the model number, and the registration date of the PC 10 in the apparatus information storage unit 142 in a correspondence manner.

Subsequently, the searching unit 153 of the local apparatus management application 152 performs communication through the communication interface 3 with a printer job language (PJL) so as to search a new local apparatus (step S112).

The apparatus 20 is connected to the communication interface 3. Therefore, the control unit 250 of the apparatus 20 transmits a response command to the PC 10 (step S114).

Subsequently, the creating unit 154 of the local apparatus management application 152 creates management information for the apparatus 20 searched by the searching unit 153 using the management information of the PC 10 that is stored in the management information storage unit 141. Then, the registration requesting unit 155 of the local apparatus management application 152 transmits a PJL command for requesting the apparatus 20 to register the management information created by the creating unit 154 to the apparatus 20 (step S116).

Thereafter, if the control unit 250 of the apparatus 20 has received the PJL command for requesting registration of the management information from the PC 10, the control unit 250 registers the management information in the management information storage unit 241. Then, the control unit 250 transmits local apparatus information including the management information, the apparatus name, the model number, and the registration date as a response command to the PC 10 (step S118).

Subsequently, the registration requesting unit 155 of the local apparatus management application 152 receives the local apparatus information from the apparatus 20 and registers the management information, the apparatus name, the model number, and the registration date of the apparatus 20 that is included in the received local apparatus information in the apparatus information storage unit 142. Then, the notifying unit 156 of the local apparatus management application 152 sets the management information, the apparatus name, the model number, and the registration date of the of the PC 10 that is stored in the apparatus information storage unit 142 to be network apparatus information of the PC 10, and notifies the apparatus management device 30 of the network apparatus information of the PC 10 together with the local apparatus information of the apparatus 20 as apparatus information through the OS 151 (step S120, S122).

Then, the management unit 354 of the apparatus management application 351 acquires the apparatus information from the PC 10 and stores the apparatus information in the apparatus information storage unit 342.

Thereafter, in the apparatus management system 1, the pieces of processing from step S124 to step S138 are performed periodically (for example, once per day).

First, the management unit 354 of the apparatus management application 351 requests the PC 10 to confirm a state of the apparatus (step S124).

Subsequently, the OS 151 of the PC 10 requests the local apparatus management application 152 to confirm a state of the apparatus (step S126).

Then, the confirmation unit 157 of the local apparatus management application 152 confirms the management information that is stored in the apparatus information storage unit 142 so as to confirm the local apparatus connected to the PC 10 (step S128). In this case, the apparatus 20 is confirmed as the local apparatus.

Subsequently, the confirmation unit 157 confirms the state of itself (PC 10) and stores the confirmation date in the apparatus information storage unit 142 so as to correspond to the management information of the PC 10 (step S130).

Then, the confirmation unit 157 transmits a PJL command for requesting confirmation of a state of the apparatus 20 to the apparatus 20 (step S132).

Subsequently, if the control unit 250 of the apparatus 20 has received the PJL command for requesting confirmation of the state from the PC 10, the control unit 250 confirms the state of itself (apparatus 20) and transmits the local apparatus information including the management information, the apparatus name, the model number, and the confirmation date as a response command to the PC 10 (step S134).

Subsequently, the confirmation unit 157 receives the local apparatus information from the apparatus 20 and stores a confirmation date included in the received local apparatus information in the apparatus information storage unit 142 so as to correspond to the management information of the apparatus 20. Then, the notifying unit 156 of the local apparatus management application 152 sets the management information, the apparatus name, the model number, and the registration date of the PC 10 that is stored in the apparatus information storage unit 142 as network apparatus information of the PC 10 and notifies (responds to) the apparatus management device 30 of the network apparatus information together with the local apparatus information of the apparatus 20 through the OS 151 (step S136, S138).

As described above, in the first embodiment, the local apparatus management program for managing the local apparatus is distributed to the PC 10 as the target to be managed by the apparatus management device 30 and the local apparatus management application 152 is realized on the PC 10. Therefore, the PC 10 can perform apparatus management on the local apparatus in a more sophisticated manner than with the conventional technique and the management information can be registered in the apparatus 20 connected to the PC 10 through the communication interface 3. Furthermore, the PC 10 notifies the apparatus management device 30 of the management information registered in the apparatus 20. Therefore, the apparatus 20 can be set as a target to be managed by the apparatus management device 30 while a user does not register manually.

### Second Embodiment

In the second embodiment, an example in which an operation state of the apparatus is analyzed is described. Hereinafter, points in the second embodiment that are different from the first embodiment are described mainly and constituent components having functions the same as those in the first embodiment are denoted with the same technical names and reference numerals as those in the first embodiment and description thereof is omitted.

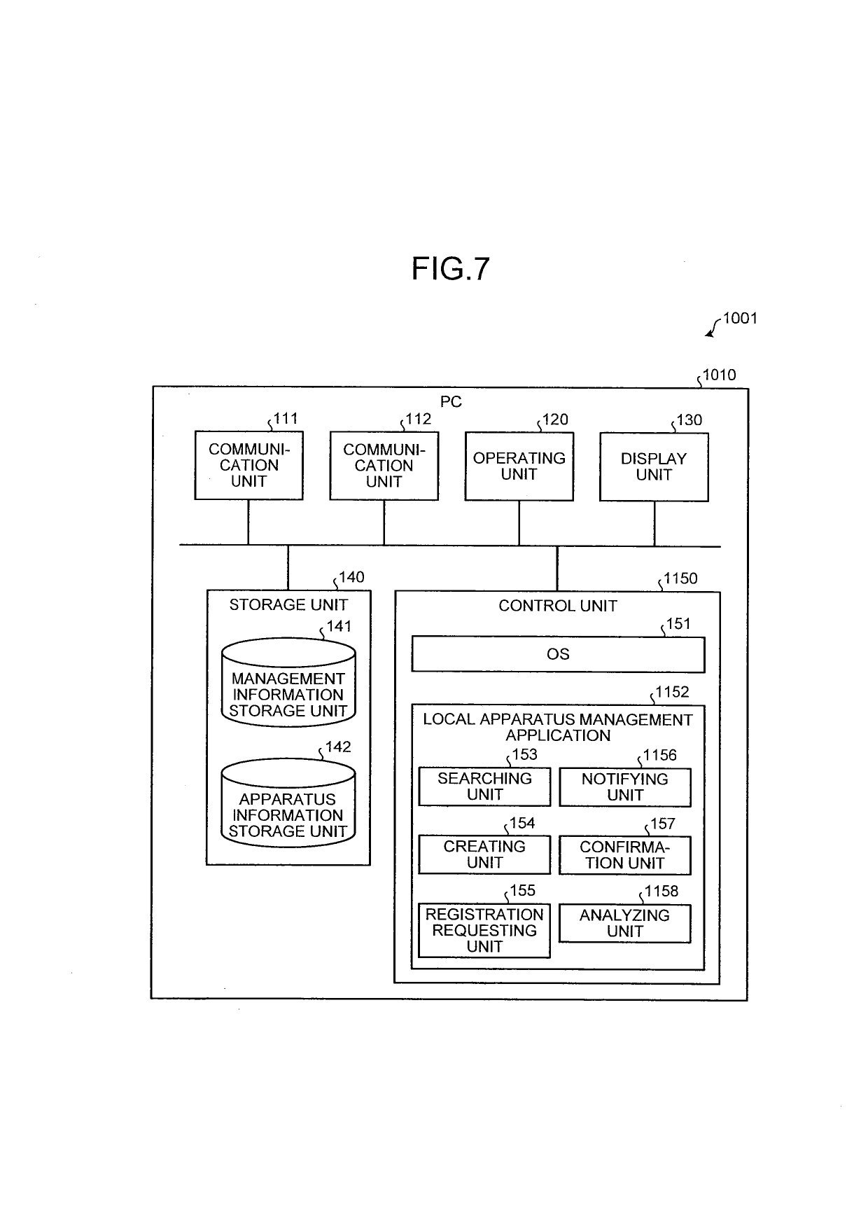

FIG. 7 is a block diagram illustrating an example of a configuration of a PC 1010 of an apparatus management system 1001 according to a second embodiment. As illustrated in FIG. 7, the PC 1010 according to the second embodiment differs from the PC 10 according to the first embodiment in that a local apparatus management application 1152 of a control unit 1150 includes an analyzing unit 1158 and also includes a notifying unit 1156.

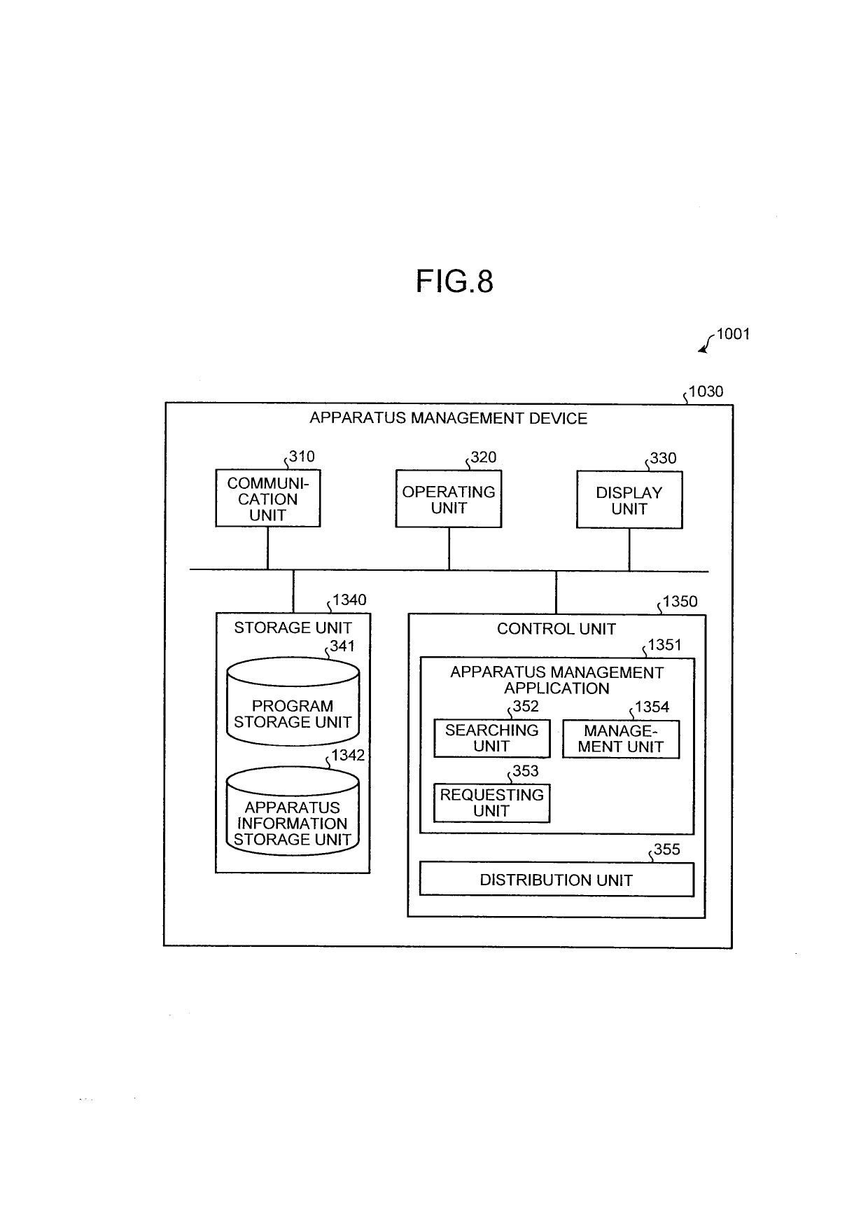

FIG. 8 is a block diagram illustrating an example of a configuration of an apparatus management device 1030 of an apparatus management system 1001 according to the second embodiment. As illustrated in FIG. 8, the apparatus management device 1030 according to the second embodiment is different from the apparatus management device 30 according to the first embodiment in an apparatus information storage unit 1342 of a storage unit 1340 and a management unit 1354 of an apparatus management application 1351 of a control unit 1350.

The analyzing unit 1158 analyzes an operation state of the apparatus 20 of which management information has been registered so as to analyze whether the apparatus 20 meets operation conditions.

If the apparatus management device 1030 requests the analyzing unit 1158 to analyze the operation state of the apparatus through an OS 151, for example, the analyzing unit 1158 acquires a registration date and a confirmation date of the PC 1010 that are stored in the apparatus information storage unit 142 and calculates an operation rate of the PC 1010 from the acquired registration date and confirmation date. For example, when state confirmation is performed by the confirmation unit 157 once per day, the analyzing unit 1158 can calculate the operation rate by dividing the number of days on which confirmation dates have been registered by the number of days from the registration date to the present date. Then, the analyzing unit 1158 analyzes whether the calculated operation rate is higher than a predetermined operation rate. Furthermore, the analyzing unit 1158 analyzes whether a non-operated period from the acquired latest confirmation date (last operation date) to the present date is longer than a predetermined period. If the operation rate is lower than the predetermined operation rate or if the non-operated period is longer than the predetermined period, the analyzing unit 1158 analyzes to conclude that the PC 1010 is idle facility. On the other hand, if the operation rate is higher than the predetermined operation rate and if the non-operated period is shorter than the predetermined period, the analyzing unit 1158 analyzes to conclude that the PC 1010 is not idle facility.

If the apparatus management device 1030 requests the analyzing unit 1158 to analyze the operation state of the apparatus, the analyzing unit 1158 also analyzes whether the apparatus 20 meets operation conditions with the above-mentioned analysis method.

The notifying unit 1156 notifies the apparatus management device 1030 of the analysis result by the analyzing unit 1158.

The notifying unit 1156 notifies the apparatus management device 1030 of the management information, the apparatus name, the model number, and the analysis result (for example, the operation rate, the non-operated period, and whether the apparatus 20 is idle facility) of the PC 1010 through the OS 151. The notifying unit 1156 also notifies the apparatus management device 1030 of the management information, the apparatus name, the model number, and the analysis result of the apparatus 20 of which operation state has been analyzed through the OS 151.

The management unit 1354 requests the network apparatuses as management targets such as the PC 1010 and the apparatuses 21 and 22 to analyze operation states thereof and acquires pieces of management information, apparatus names, model numbers, registration dates, and the analysis results of the network apparatuses. Then, the management unit 1354 stores the acquired analysis results in the apparatus information storage unit 1342 so as to correspond to the pieces of management information of the network apparatuses.

When a local apparatus is connected to the network apparatus to which the state confirmation has been requested through the communication interface 3, the management unit 1354 also acquires the management information, the apparatus name, the model number, and the analysis result of the local apparatus from the network apparatus. Then, the management unit 1354 stores the acquired analysis result in the apparatus information storage unit 1342 so as to correspond to the management information of the local apparatus.

Furthermore, the management unit 1354 displays a confirmation screen of the pieces of information of the apparatuses as the management targets such as the PC 1010 and the apparatuses 20 to 22 on the display unit 330.

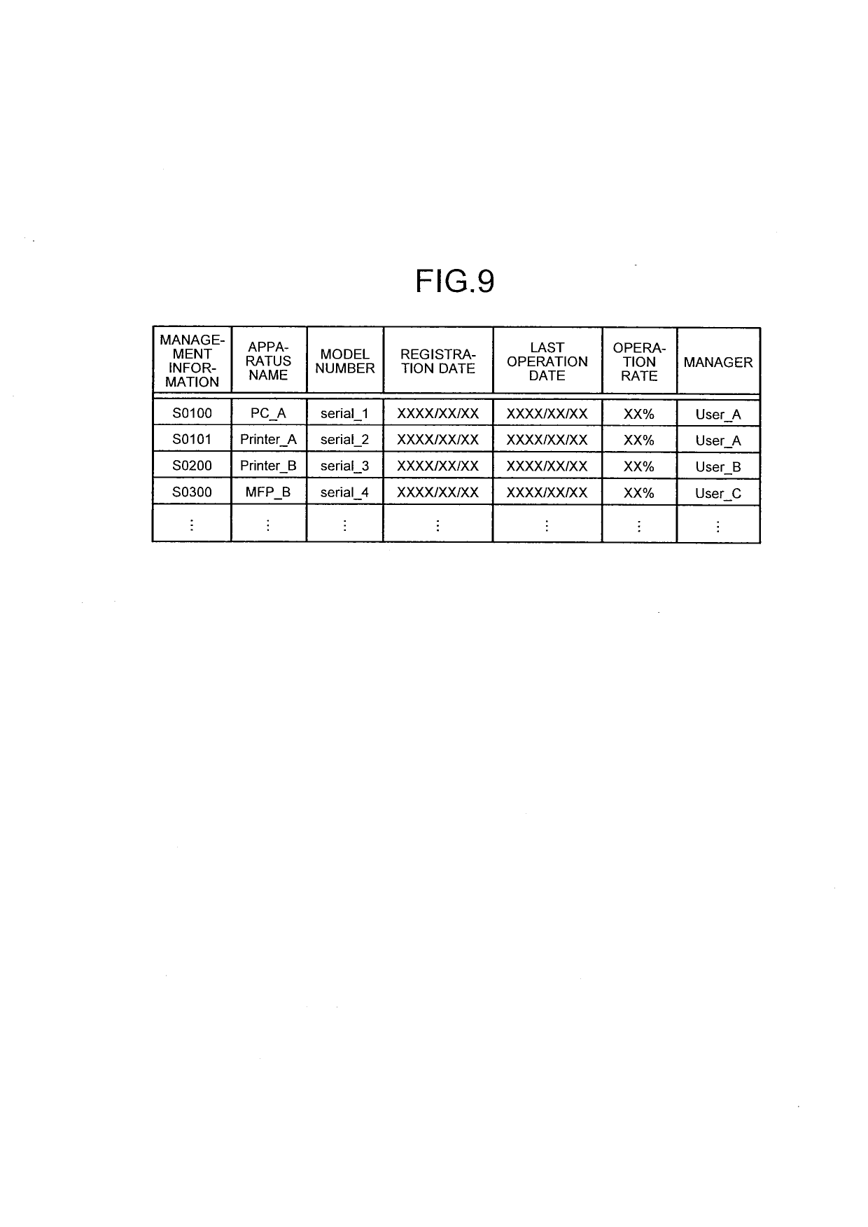

FIG. 9 is a diagram illustrating an example of the confirmation screen according to the second embodiment. In the example as illustrated in FIG. 9, the management unit 1354 generates a confirmation screen using the pieces of management information, the apparatus names, the model numbers, the registration dates, latest confirmation dates (corresponding to last operation dates), operation rates and pieces of manager information (corresponding to managers) that are stored in the apparatus information storage unit 1342 and displays the generated confirmation screen on the display unit 330. It is to be noted that apparatuses as idle facilities may be displayed in a form (for example, expressed in red) indicating that the apparatuses are idle facilities.

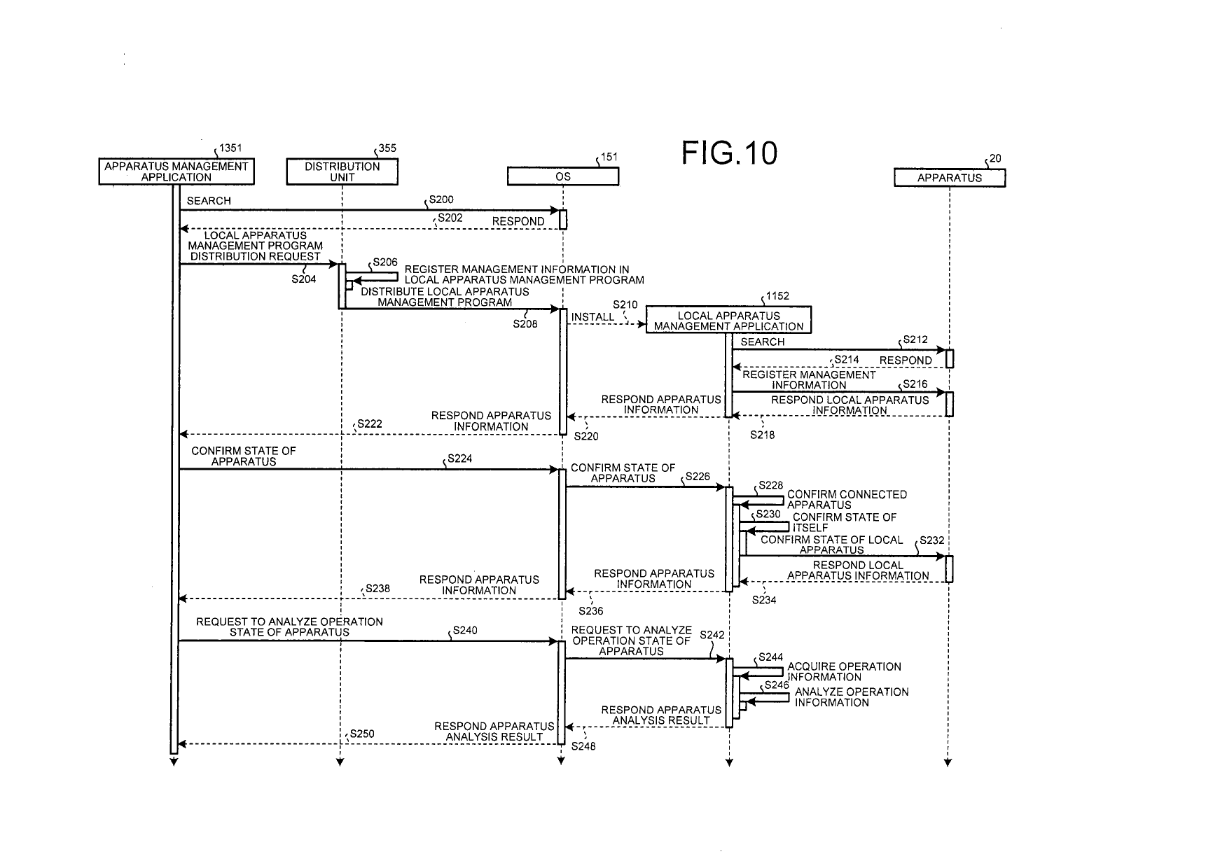

FIG. 10 is a sequence diagram illustrating an example of processing that is executed on the apparatus management system 1001 according to the second embodiment.

First, pieces of processing from step S200 to step S238 are the same as the pieces of processing from S100 to S138 in the sequence diagram as illustrated in FIG. 6.

Subsequently, the management unit 1354 of the apparatus management application 1351 requests the PC 1010 to analyze an operation state of the apparatus (step S240).

Then, the OS 151 of the PC 1010 requests the local apparatus management application 1152 to analyze an operation state of the apparatus (step S242).

Thereafter, the analyzing unit 1158 of the local apparatus management application 1152 acquires a registration date and a confirmation date of each of the PC 1010 and the apparatus 20 as operation information from the apparatus information storage unit 142 (step S244).

Subsequently, the analyzing unit 1158 calculates an operation rate and a non-operated period for each of the PC 1010 and the apparatus 20 using the acquired operation information and analyzes whether each of the PC 1010 and the apparatus 20 is idle facility (step S246).

Then, the notifying unit 1156 of the local apparatus management application 1152 notifies (responds to) the apparatus management device 1030 of the management information, the apparatus name, the model number, and the analysis result of the PC 1010 and the management information, the apparatus name, the model number, and the analysis result of the apparatus 20 as apparatus analysis results through the OS 151 (step S248, S250).

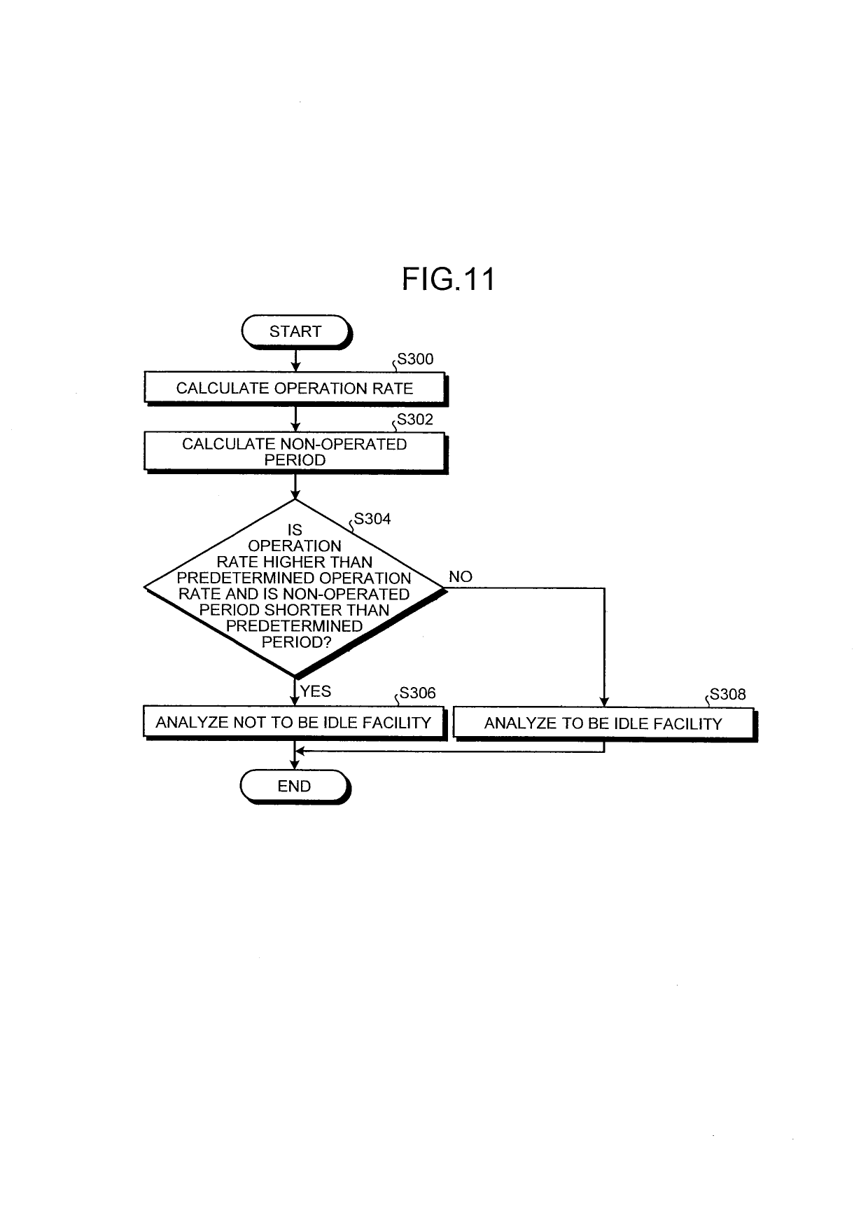

FIG. 11 is a flowchart illustrating an example of operation state analysis processing that is executed by the analyzing unit 1158 of the local apparatus management application 1152 according to the second embodiment. In this case, the state confirmation is assumed to be performed by the confirmation unit 157 once per day. Furthermore, description is made by taking the apparatus 20 as an example but the same holds true for the PC 1010.

First, the analyzing unit 1158 acquires the registration date and the confirmation date of the apparatus 20 that are stored in the apparatus information storage unit 142 and calculates an operation rate by dividing the number of days on which confirmation dates have been registered by the number of days from the registration date to the present date (step S300).

Subsequently, the analyzing unit 1158 calculates a non-operated period from the acquired latest confirmation date (last operation date) to the present date (step S302).

Subsequently, the analyzing unit 1158 determines whether the operation rate is higher than a predetermined operation rate and the non-operated period is shorter than a predetermined period (step S304).

If the operation rate is higher than the predetermined operation rate and the non-operated period is shorter than the predetermined period (Yes at step S304), the analyzing unit 1158 analyzes to conclude that the apparatus 20 is not idle facility (step S306).

On the other hand, if the operation rate is lower than the predetermined operation rate or the non-operated period is longer than the predetermined period (No at step S304), the analyzing unit 1158 analyzes to conclude that the apparatus 20 is idle facility (step S308).

As described above, in the second embodiment, the apparatus management device 1030 can manage the operation state of the local apparatus through the PC 1010.

### Hardware Configuration

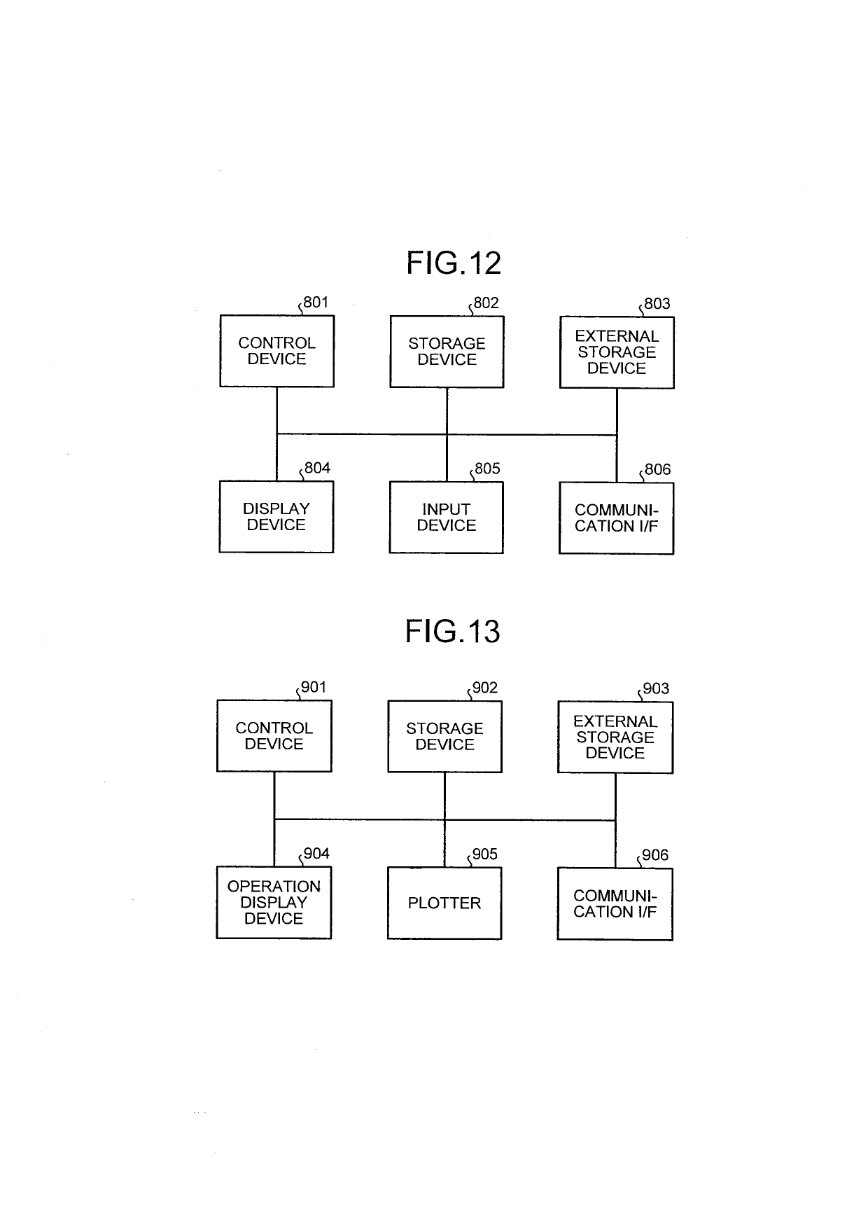

FIG. 12 is a block diagram illustrating an example of a hardware configuration of the PC and the apparatus management device according to the first and the second embodiments. As illustrated in FIG. 12, each of the PC and the apparatus management device according to the above-mentioned embodiments includes a control device 801 such as a CPU, a storage device 802 such as a ROM and a RAM, an external storage device 803 such as an HDD and an SSD, a display device 804 such as a display, an input device 805 such as a mouse and a keyboard, and a communication I/F 806 such as an NIC. Each of the PC and the apparatus management device can be realized by a hardware configuration using a conventional computer.

The local apparatus management program to be executed on the PC and the apparatus management program to be executed on the apparatus management device in the above-mentioned embodiments are provided by being recorded in a recording medium that can be read by a computer, such as a compact disc read only memory (CD-ROM), a flexible disk (FD), a CD recordable (CD-R), or a digital versatile disk (DVD), in a format that can be installed or a file that can be executed.

The local apparatus management program to be executed on the PC and the apparatus management program to be executed on the apparatus management device in the above-mentioned embodiments may be provided by being stored on a computer connected to network such as the Internet and being downloaded through the network. Alternatively, the local apparatus management program to be executed on the PC and the apparatus management program to be executed on the apparatus management device in the above-mentioned embodiments may be provided or distributed through network such as the Internet. Furthermore, the local apparatus management program to be executed on the PC and the apparatus management program to be executed on the apparatus management device in the above-mentioned embodiments may be provided by being incorporated in a ROM or the like previously.

The local apparatus management program to be executed on the PC and the apparatus management program to be executed on the apparatus management device in the above-mentioned embodiments have module configurations for realizing the above-described parts on a computer. In actual hardware, the control device 801 loads the programs from the external storage device 803 and executes the programs, so that the above-described parts are realized on the computer.

FIG. 13 is a block diagram illustrating an example of the hardware configuration of the apparatus according to the first and the second embodiments. As illustrated in FIG. 13, the apparatus in the above-mentioned embodiments can be realized by a hardware configuration using a computer including a control device 901 such as a CPU, a storage device 902 such as a ROM and a RAM, an external storage device 903 such as an HDD and an SSD, an operation display device 904 such as a touch panel display, a plotter 905, and a communication I/F 906 such as an NIC and a USB.

### Modifications

It is to be noted that the invention is not limited to the above-mentioned embodiments and various modifications can be made.

For example, in the above-mentioned embodiments, the apparatus management device distributes the local apparatus management program. However, a configuration in which a server device is provided separately and processing contents of the distribution unit of the apparatus management device are performed on the server device may be employed.

For example, in the second embodiment, an example in which the analysis of the operation state of the apparatus is also executed by the local apparatus management application has been described. However, the processing contents of the analyzing unit of the local apparatus management application may be performed on another application.

In the embodiments, the apparatus management device can set apparatuses connected to the information processing device as targets to be managed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device that is capable of communicating with an apparatus through a first communication path and is capable of communicating with an apparatus management device for managing the apparatus through a second communication path, the information processing device comprising:
a searching unit that searches apparatuses capable of communicating with the information processing device;
a registration requesting unit that requests the apparatus capable of communicating with the information processing device through the first communication path among the searched apparatuses to register thereto management information for the apparatus; and
a notifying unit that notifies the apparatus management device of the management information based on notification indicating a fact that the management information has been registered from the apparatus.

2. The information processing device according to claim 1, further comprising a creating unit that creates the management information for the apparatuses searched by the searching unit.

3. The information processing device according to claim 2, wherein the creating unit creates the management information for the apparatuses using management information for the information processing device that has been previously set by the apparatus management device.

4. The information processing device according to claim 3, further comprising a management information storage unit that stores therein the management information that has been previously set by the apparatus management device.

5. The information processing device according to claim 1, further comprising a confirmation unit that confirms a state of the apparatus for which management information has been registered, wherein
the notifying unit notifies the apparatus management device of a confirmation result by the confirmation unit.

6. The information processing device according to claim 1, further comprising an analyzing unit that analyzes an operation state of the apparatus for which the management information has been registered and analyzes whether the apparatus meets operation conditions, wherein
the notifying unit notifies the apparatus management device of an analysis result by the analyzing unit.

7. An apparatus management system comprising:
an information processing device that is capable of communicating with an apparatus through a first communication path and is capable of communicating with an apparatus management device for managing the apparatus through a second communication path, and
the apparatus management device, wherein
the information processing device includes:
a searching unit that searches apparatuses capable of communicating with the information processing device;
a registration requesting unit that requests the apparatus capable of communicating with the information processing device through the first communication path among the searched apparatuses to register thereto management information for the apparatus; and
a notifying unit that notifies the apparatus management device of the management information based on notification indicating a fact that the management information has been registered from the apparatus, and
the apparatus management device includes a management unit that manages the apparatus based on the management information notified from the information processing device.

8. A computer program product comprising a non-transitory computer usable medium having computer readable program codes embodied in the medium that when executed causes a computer that is capable of communicating with an apparatus through a first communication path and is capable of communicating with an apparatus management device for managing the apparatus through a second communication path to execute a method comprising:
searching apparatuses capable of communicating with the information processing device;
transmitting a registration request of management information to the apparatus capable of communicating with the information processing device through the first communication path among the searched apparatuses; and
notifying the apparatus management device of the management information based on notification indicating a fact that the management information has been registered from the apparatus.
